(19) United States
(12) Patent Application Publication
(10) Pub. No.: US 2007/0165365 A1
(43) Pub. Date: Jul. 19, 2007

(54) Structure of terminal protection cover of electronic apparatus and terminal protection cover attaching method

(76) Inventor: Shinichi Kamiya, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/588,441

(22) PCT Filed: Feb. 10, 2005
(86) PCT No.: PCT/JP05/02518

§ 371 Date: Aug. 7, 2006

(30) Foreign Application Priority Data
Feb. 10, 2004 (JP) 2004-032780

(51) Int. Cl. H05K 5/00

(52) U.S. Cl. 361/679

(57) ABSTRACT

It is designed in that the terminal protection cover for an electronic apparatus can be inserted into the body only in one direction different from the attached direction at a time of using the protection cover, hence to prevent from dropout of the terminal protection cover in any other direction than the inserting direction. Further, the terminal protection cover is made from elastic material such as rubber and the like, and a combination of a tongue-shaped piece and a protrusion is used for a hook, hence to make the terminal protection cover difficult to drop out even when the terminal protection cover is rotated from the ordinary attached direction at a time of using the external terminal to the inserting direction at the attachment time.

### 1. FIELD OF THE INVENTION

The invention relates to an electronic apparatus, and more particularly to the structure of a terminal protection cover for an electronic apparatus and its attaching method.

### 2. DESCRIPTION OF THE RELATED ART

A terminal protection cover attached to an electronic apparatus, hereinto, has a shaft inserted into an opening of the body, which is fixed to the body by a hook formed at the distal end of the shaft. Unfortunately, the protection cover pulls out easily because it is fixed only by insertion. In order to prevent from this, it is considered that the hook is enlarged, but this time, the shaft is difficult to insert into the body.

On the other hand, there is a method in which the hook of a shaft of a terminal protection cover is enlarged, the hole of the body is arranged on the slit line of a case and a cover, and the protection cover is built in before attaching the cover to the case of the body. In this case, however, when the protection cover drops, it must be built in after disassembling the body. When the hook at the distal end of the shaft is enlarged for further fixation, there is a fear of damaging the body at a time of strongly pulling the protection cover.

The structure of the conventional terminal protection cover for an electronic apparatus will be described with reference to FIG. 1.

FIG. 1 is an exploded perspective view of the structure of the conventional terminal protection cover for an electronic apparatus. Here, the electronic apparatus comprises a body 1000 and a terminal protection cover 500. The body 1000 is provided with two rectangular openings 28 and 30 for embedding the terminal protection cover 500. The terminal protection cover 500 has a main body 20 of the protection cover, a rectangular column 15, and a hook 16.

By embedding the rectangular column 15, the hook 16, and the main body 20 of the protection cover in the two rectangular openings 28 and 30 on the side of the body 1000, the terminal protection cover 500 is attached to the body 1000, and by hanging the hook 16 on a fringe portion of the rectangular opening 28 in the body, the terminal protection cover 500 can be prevented from pulling out.

At this time, the structure of the conventional terminal protection cover for an electronic apparatus has the following problems.

At first, since the direction of attaching the terminal protection cover to the body is the same as the direction at a time of using the cover, unless insertion of the hook is firmly secured, the protection cover may drop out easily at a time of use. When the size of the hook is enlarged to strengthen the effect of dropout prevention, there arises another problem that the cover is difficult to attach.

Secondly, since the inserting portion of the terminal protection cover 500 into the body 1000 is formed into the rectangular column 15, the main body 20 of the protection cover cannot rotate after the terminal protection cover 500 is attached to the body 1000. Actually, when using the external terminal of the body, a plug and the like is difficult to insert into the terminal because of existence of the terminal protection cover.

Some proposals have been made so far for the above mentioned terminal protection cover for an electronic apparatus and its attaching method.

For example, in the “Cap for Opening and Closing, and Apparatus Body Using the Same; Patent Publication Laid-Open No. 2001-7556”, a cap for opening and closing, integrally formed by an elastic member, having a covering cap for an opening and an attaching shaft which enables the rotation of the cap main body, is proposed for the purpose of covering the opening portion provided in the main body of the apparatus.

In the “Connector Protection Cover Attaching Structure; Japanese Patent Publication Laid-Open No. 2002-141679”, a protection cover made from elastic material is proposed, which is attached to the opening of the body to cover it in such a way that the body surface with the cover attached becomes smooth. This protection cover is rotatable around a shaft orthogonal to the body surface where the opening is formed, hence to release or cover the opening.

In the “Waterproof Cap Structure; Japanese Patent Publication Laid-Open No. 2003-217734”, the structure of a collective waterproof cap comprising a plurality of waterproof pieces and a common hinge is proposed, for covering the connector opening portion.

In the “Cap Structure of External Connection Terminal of Electronic Apparatus; Japanese Patent Laid-Open No. 10-255900”, a cap structure comprising a rotational shaft and a cap main body provided on the distal end of the rotational shaft near the external connection terminal provided on the body, is proposed, for the purpose of providing a cap structure of external connection terminal of electronic apparatus improved in handling and appearance quality, which can protect the external connection terminal of electronic apparatus.

In this cap structure, the cap main body is further provided with an engaging protrusion for engaging with the terminal inserting portion of the body and a concave portion for engaging with the engaging protrusion is formed also in a place other than the terminal inserting portion of the body. Thanks to this structure, the cap main body is rotated around the rotational shaft and it can be engaged with the cap main body at one of the above engaging portions.

An object of the invention is to provide the structure of a terminal protection cover which can be easily attached to the body and difficult to drop out, in an electronic apparatus having the terminal protection cover.

### SUMMARY OF THE INVENTION

Hereinafter, the means for solving the problems will be described by using the parenthetical reference numbers used for the Best Mode for Carrying Out the Invention. These reference numbers are attached in order to make clear a correspondence between the description of the What is Claimed is and the description of the Best Mode for Carrying Out the Invention and they should not be used for the description of the technical scope of the invention described in the “What is Claimed is”.

An electronic apparatus according to the invention comprises a body including a first attached body portion (21) and a second attached body portion (26) and a terminal protection cover (50) including a first attaching cover portion (11), (12), (13) and a second attaching cover portion (10), in which after the first attaching cover portion (11), (12), (13) is attached to the first attached body portion (21), the second attaching cover portion (10) is rotated around the first attaching cover portion (11), (12), (13) and the second attaching cover portion (10) is fitted to the second attached body portion (26).

In the electronic apparatus of the invention, according to Claim 1, the first attached body portion and the second attached body portion are a first opening (21) and a second opening (26) aligned in the first direction, the first attaching cover portion and the second attaching cover portion are respectively a rotational shaft portion (11), (12), (13) to be inserted into the first opening (21) and a cover main portion (10) to be fitted into the second opening (26), and after the rotational shaft portion (11), (12), (13) is inserted into the first opening (21), the cover main portion (10) is rotated around the rotational shaft portion (11), (12), (13) and the cover main portion (10) is fitted into the second opening (26).

In the electronic apparatus of the invention, according to Claim 2, the first opening (21) is an oval having its longitudinal direction in the second direction, the second opening (26) is a rectangular having its longitudinal direction in the first direction, the rotational shaft portion includes a cylindrical shaft (11) and a hook (12), (13) at the distal end of the shaft, the cover main portion (10) has a shape to be fitted into the second opening (26), and after the shaft and hook are inserted into the oval opening (21), the cover main portion (10) is rotated around the shaft and the cover main portion (10) is fitted into the rectangular opening (26).

In the electronic apparatus of the invention, according to Claim 3, the hook includes a tongue-shaped piece (12) and a protrusion (13) in the longitudinal direction of the cover main portion (10), with the shaft (11) intervening therebetween.

In the electronic apparatus of the invention, according to Claim 3, the hook includes the tongue-shaped piece (12) and the protrusion (13) in the longitudinal direction of the cover main portion (10), with the shaft (11) intervening, and two small protrusions (14) arranged in a direction perpendicular to the longitudinal direction of the cover main body, with the shaft (11) intervening.

In the electronic apparatus of the invention, according to Claim 1 to Claim 5, the terminal protection cover (50) is made from elastic material.

The electronic apparatus of the invention, according to Claim 1 to Claim 5, is applied to a mobile phone.

A method of attaching a terminal protection cover for an electronic apparatus according to the invention, in the electronic apparatus comprising a body (100) including an oval opening (21) having its longitudinal direction in the second direction and a rectangular opening (26) having its longitudinal direction in the first direction, which openings are aligned in the first direction, and a terminal protection cover (50) rotatable and including a rotational shaft portion having a hook (12), (13) at the distal end of a cylindrical shaft (11) and a cover main portion (10) formed into a shape to be fitted into the rectangular opening (26), comprises: a step of inserting the rotational shaft into the oval opening (21), and a step of rotating the cover main portion (10) around the rotational shaft and fitting the cover main portion (10) to the rectangular opening (26).

### BRIEF DESCRIPTION OF THE DRAWINGS

FIG. 1 is an exploded perspective view of the structure of the conventional terminal protection cover for an electronic apparatus;

FIG. 2 is an exploded perspective view of the structure of a terminal protection cover for an electronic apparatus according to a first embodiment of the invention;

FIG. 3 is an exploded perspective view showing appearance of the structure of the terminal protection cover for an electronic apparatus according to the first embodiment of the invention;

FIG. 4 is a view showing the state of assembling the terminal protection cover according to the first embodiment of the invention;

FIG. 5 is a cross-sectional view taken along the line A-A′ in FIG. 4;

FIG. 6 is a perspective view showing appearance of the terminal protection cover according to a second embodiment of the invention;

FIG. 7 is a perspective view showing appearance of the terminal protection cover according to a third embodiment of the invention;

FIG. 8 is a perspective view showing a terminal opening and an oval hole of the body and the terminal protection cover according to the third embodiment of the invention;

FIG. 9 is a partly-enlarged view of a rotational shaft of the terminal protection cover according to the third embodiment of the invention;

FIG. 10 is a plan view of the oval hole of the terminal opening of the body according to the third embodiment of the invention; and

FIG. 11 is a cross-sectional view of the oval hole forming a protection cover attaching portion of the body according to the third embodiment of the invention.

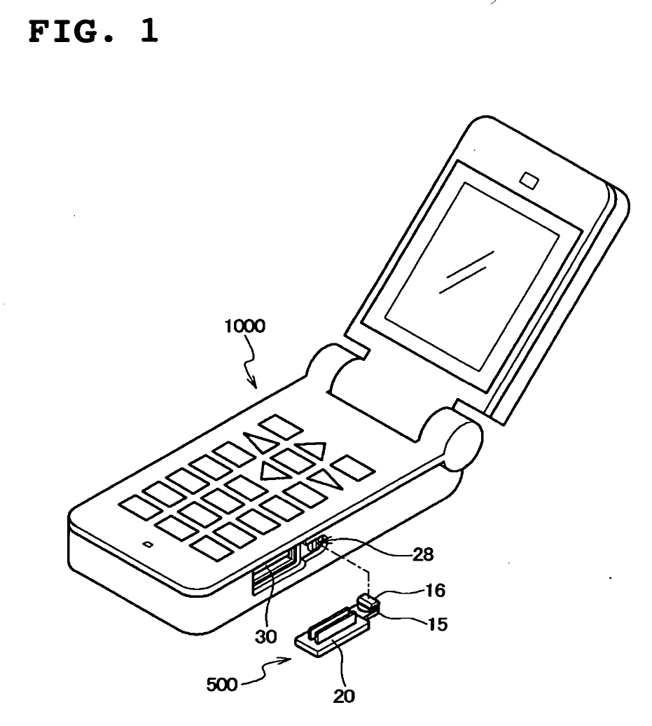

### DESCRIPTION OF THE PREFERRED EMBODIMENT

The best mode for carrying out the structure of a terminal protection cover for an electronic apparatus and the terminal protection cover attaching method according to the invention will be described referring to the accompanying drawings.

### First Embodiment

The invention is characterized by realizing the structure of a terminal protection cover which can be attached to an electronic apparatus easily and difficult to drop out, in the electronic apparatus having a terminal protection cover.

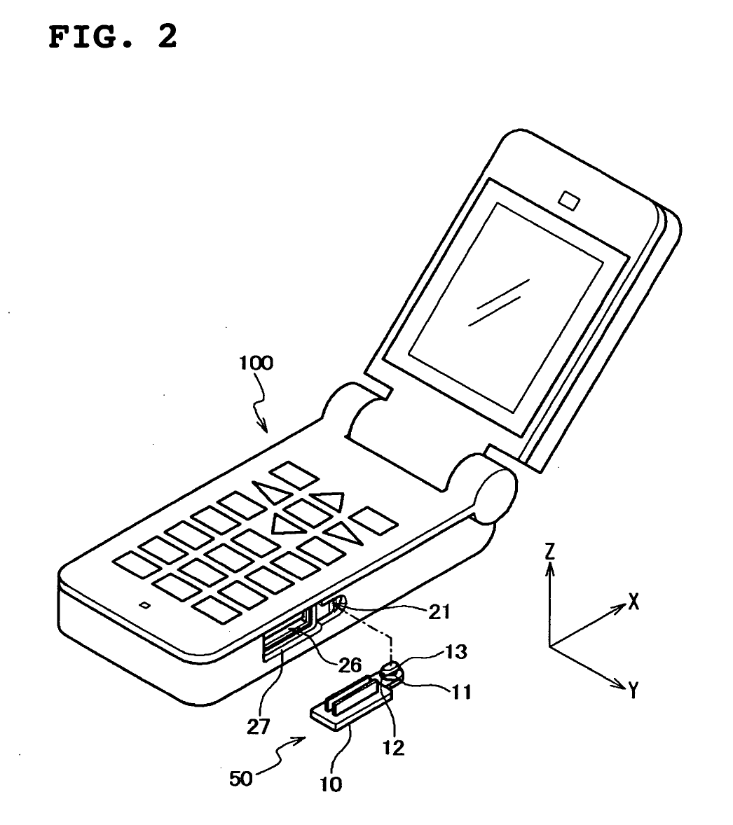

FIG. 2 is an exploded perspective view showing the characteristic of the invention. In FIG. 2, the electronic apparatus according to the invention comprises a body 100 and a terminal protection cover 50.

The terminal protection cover 50 includes a protection cover main portion 10, a cylindrical shaft forming a rotational shaft portion 11, a tongue-shaped piece 12, and a protrusion 13. The protection cover main portion 10, the rotational shaft portion (cylindrical shaft 11, tongue-shaped piece 12, and protrusion 13) are formed in one direction, and the protection cover main portion 10 covers a terminal opening 27 (described later) arranged in the body, to protect from dust at a time of no use of the external terminal.

The protection cover main portion 10 is substantially formed into the same shape as the concave portion of the terminal opening 27 of the body 100, and when the terminal protection cover 50 is attached to the body 100, the surface level of the both becomes equal without space. The rotational shaft portion includes the cylindrical shaft 11, the tongue-shaped piece 12 forming a hook at the distal end of the cylindrical shaft 11, and the protrusion 13. The hook is formed by combination of the tongue-shaped piece 12 formed in the longitudinal inward direction of the protection cover main portion 10 and the protrusion 13 formed in the longitudinal external direction.

The rotational shaft portion (cylindrical shaft 11, tongue-shaped piece 12, and protrusion 13) is to fix the protection cover main portion 10 to the body 100 assuredly and to rotate the protection cover main portion 10 from the terminal position of the body 100 to open the terminal opening 27 at a time of using the external terminal. At a time of using the external terminal, the rotational shaft portion 11, 12, 13 is also to fix the terminal protection cover 50 to the body 100. The terminal protection cover 50 is integrally made from elastic material (rubber and the like).

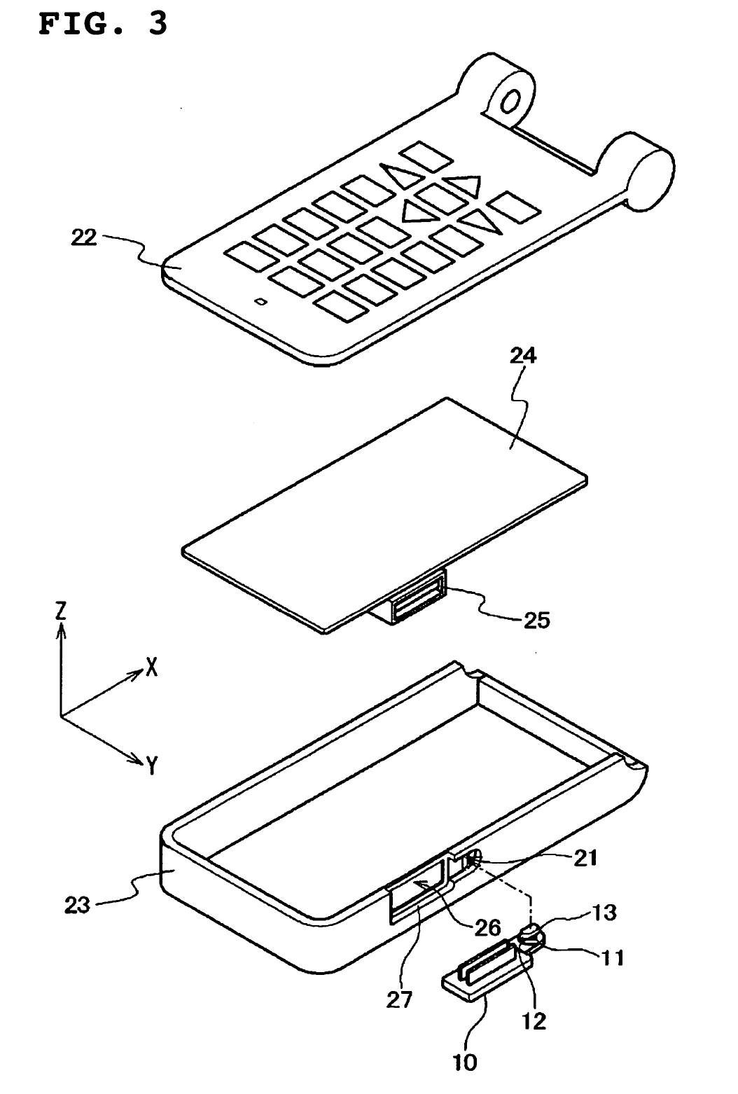

FIG. 3 is an exploded perspective view in the invention. The body 100 includes a case 22 and a cover 23. The body 100 further includes a print circuit board 24 and the external terminal 25 is installed on the print circuit board 24.

The cover 23 includes the terminal opening 27 where the external terminal 25 is arranged and a protection cover attaching portion. The terminal opening 27 is shaped into concave and in the middle thereof, a rectangular hole 26 that is a communicating window to the external terminal 25 from the outside of the body is formed in such a way that its longitudinal direction is positioned in the longitudinal direction (X-axis direction) of the body. An oval hole 21 is formed in the protection cover attaching portion in such a way that its longitudinal direction of the oval is positioned at right angle (in the direction of Z-axis) to the longitudinal direction (X-axis direction) of the body 100.

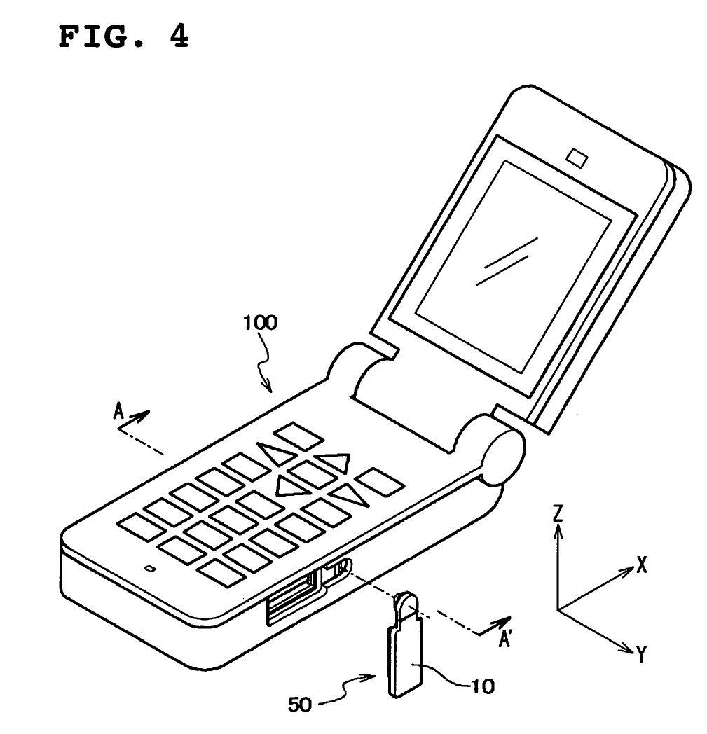

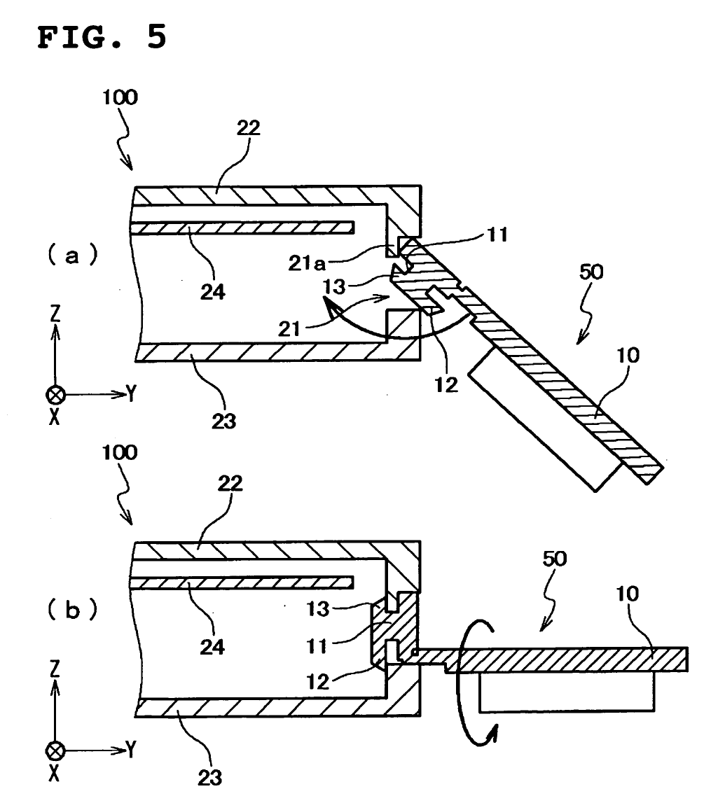

This time, the principle of the operation according to the first embodiment of the invention will be described. FIG. 4 is a view showing the state of assembling the protection cover according to the invention and FIG. 5 is a cross-sectional view taken along the line A-A′ in FIG. 4.

When attaching the terminal protection cover 50 to the body 100, as illustrated in FIG. 5 (a), (1) the longitudinal direction of the terminal protection cover 50 is put in the longitudinal direction (Z-axis direction) of the oval hole 21 of the body 100, (2) the protrusion 13 of the rotational shaft portion of the terminal protection cover 50 is inserted into the oval hole 21 toward its center and rotated through the fringe portion 21a (as a supporting point) in the longitudinal direction of the oval hole 21, and then the tongue-shaped piece 12 is pushed into the oval hole (FIG. 5(b)). Thereafter, the terminal protection cover 50 is rotated around the cylindrical shaft 11 at 90 degrees, and the protection cover main portion 10 is fixed to the terminal opening 27 of the body 100.

In FIG. 5(b), since the portion near the rotational shaft 11 collides with a stepped portion in front of the hole 21 and the protection cover main portion 10 is bent substantially at right angle, apparently the terminal protection cover 50 may seem impossible to rotate around the rotational shaft 11. The terminal protection cover 50, however, is made of elastic material (rubber and the like), and therefore the portion coming into contact with the stepped portion in front of the hole 21 of the protection cover main portion 10 can be deformed, which enables the cover to rotate easily as mentioned above.

When the protection cover main portion 10 is fixed to the terminal opening 27 of the body 100 after the rotation, the bent portion of the protection cover main portion 10 is to be accommodated into the concave formed between the hole 21 and the terminal opening 27.

According to this, the hook (the protrusion 13 and the tongue-shaped piece 12) of the terminal protection cover 50 is hung on the fringe 21a of the oval hole 21 of the body 100 and the body wall, which prevents from dropout of the terminal protection cover 50.

At a use of the external terminal 25, the cover main portion 10 can be not only removed from the terminal opening 27 of the body but also rotated around the shaft 11. At this time, it is needless to say that the terminal protection cover 50 can be difficult to pull out in any other direction than the inserting direction of the terminal protection cover 50 into the body 100, and the hook can secure the fixation of the terminal protection cover 50 to the body 100 also in the inserting direction. Therefore, the terminal protection cover 50 will not drop out from the body 100 easily.

### Second Embodiment

In the second embodiment of the invention, although its basic structure is the same as that of the first embodiment, the shape of the hook forming the rotational shaft portion of the terminal protection cover is further improved.

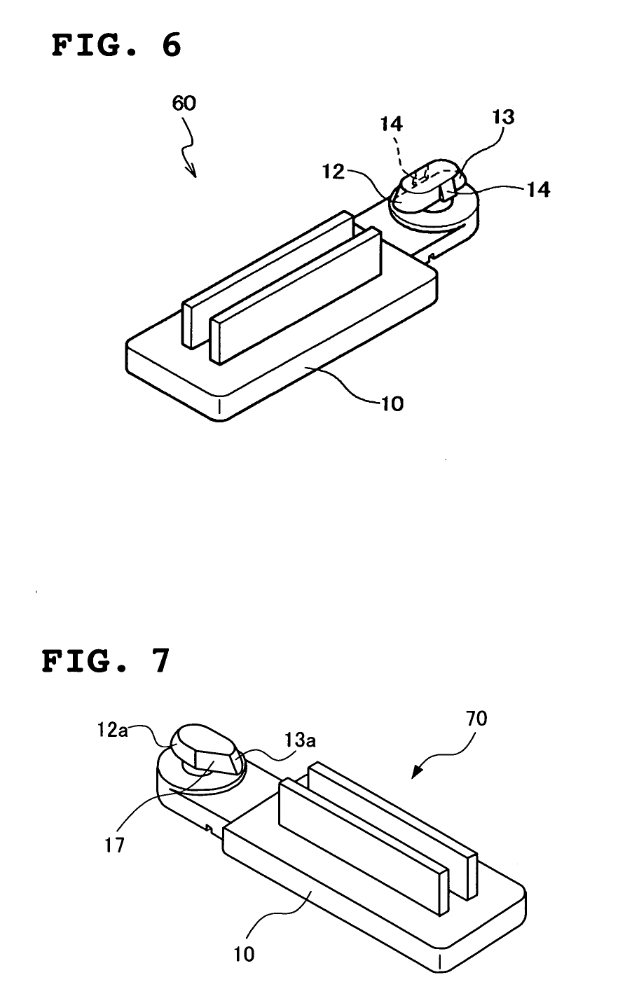

FIG. 6 is a perspective view showing appearance of a terminal protection cover 60 according to the second embodiment of the invention. In addition to the tongue-shaped piece 12 and the protrusion 13 of the hook in the first embodiment, the hook of the terminal protection cover 60 according to the second embodiment is provided with small protrusions 14 in the direction perpendicular to the direction of aligning the tongue-shaped piece 12 and the protrusion 13.

As illustrated in FIG. 6, the small protrusion 14 is formed at the both sides of the tongue-shaped piece 12 and the protrusion 13, integrally with the tongue-shaped piece 12 and the protrusion 13, with an inclined surface expanding from the inner (inserted) side of the tongue-shaped piece 12 and the protrusion 13 to the outside. The top surface of the small protrusion 14 near the cylindrical shaft 11 is formed at the same level as the surface of the tongue-shaped piece 12 and the protrusion 13.

When the terminal protection cover 60 is attached to the body 100, the small protrusions 14 are hung on the wall of the body 100 and the fringe 21a of the oval hole 21, hence to prevent the terminal protection cover 60 from dropping out.

Thus, by providing the hook of the terminal protection cover with the small protrusions 14, in the second embodiment of the invention, dropout preventive force can be further strengthened, in the inserting direction at the attachment time.

As mentioned above, since the small protrusion 14 is shaped into expanding from the inner (inserted) side to the outside, when the tongue-shaped piece 12 and the protrusion 13 of the terminal protection cover 60 is inserted into the oval hole 21, the inclined surfaces of the small protrusions 14 get over the fringe 21a (brim) of the hole 21 easily, which makes the insertion of the tongue-shaped piece 12 and the protrusion 13 easy, and after getting over the fringe (brim) 21a of the hole 21, the top surfaces of the small protrusions 14 are hung on the fringe 21a of the hole 21 firmly, hence to obtain a satisfactory effect of preventing dropout of the terminal protection cover 60.

### Third Embodiment

In the third embodiment of the invention, although its basic structure is the same as that of the first embodiment, further improvement is added to the shape of the hook forming the rotational shaft portion of the terminal protection cover and the oval hole 21A forming the protection cover attaching portion of the body 100.

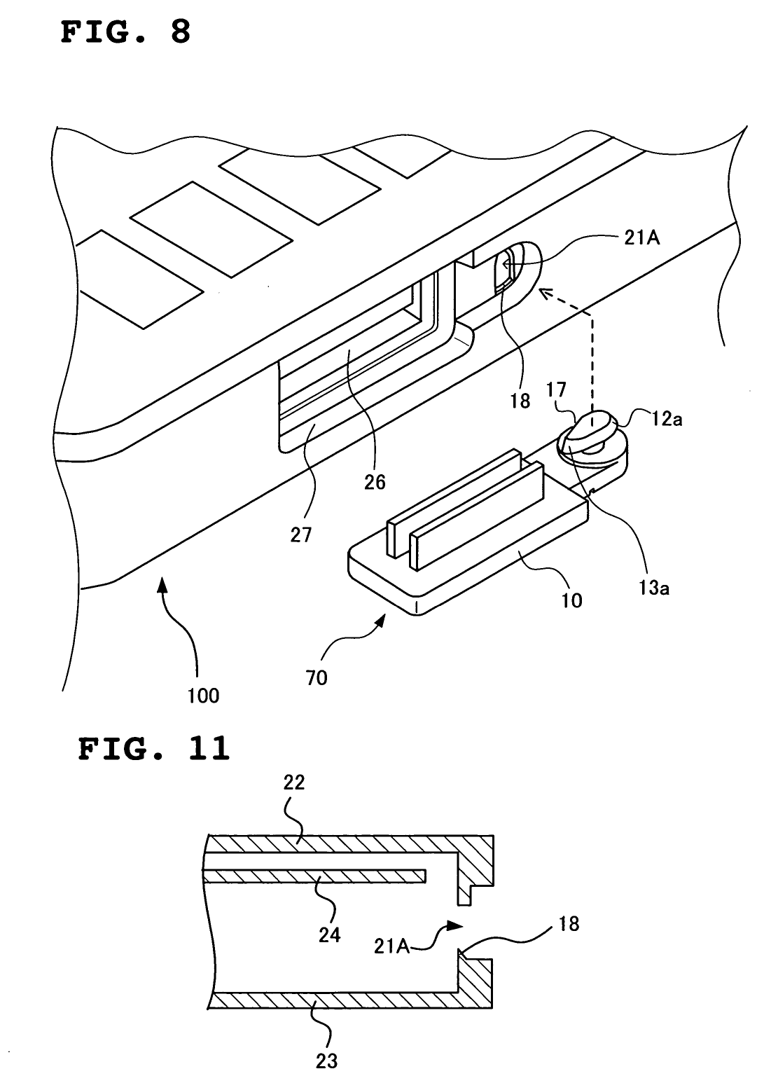

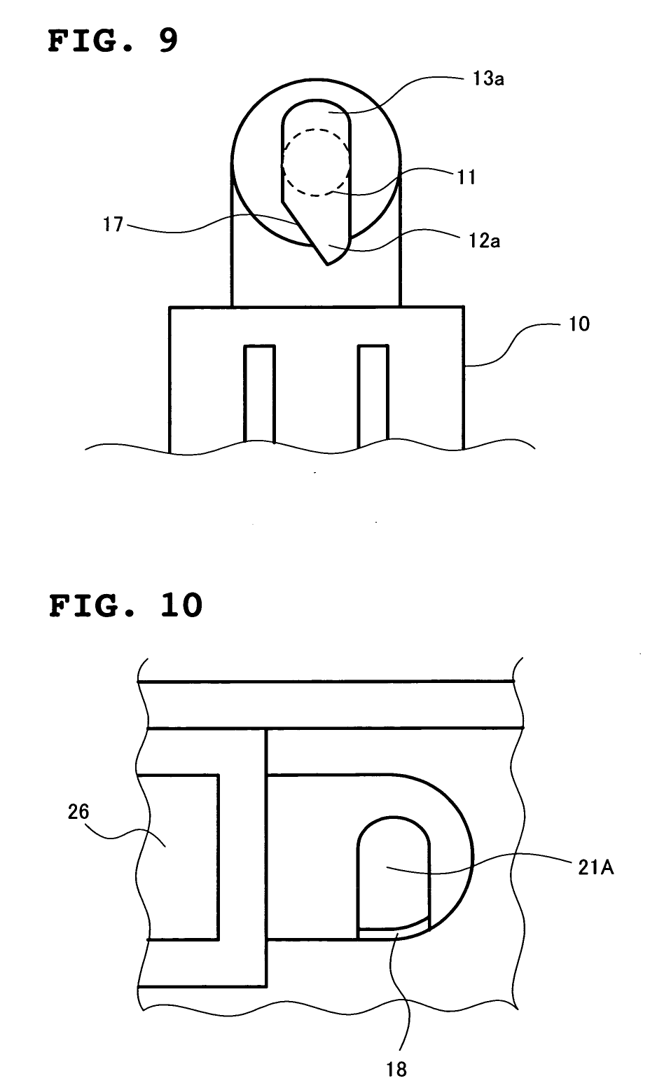

FIG. 7 is a perspective view showing appearance of a terminal protection cover 70 according to the third embodiment of the invention. FIG. 8 is a perspective view showing a terminal opening 27 having a rectangular hole 26 of the body 100, an oval hole 21A forming a protection over attaching portion of the body 100, and the terminal protection cover 70. FIG. 9 is a partly enlarged view of a rotational shaft of the terminal protection cover, and FIG. 10 is a plan view of the oval hole of the terminal opening of the body.

As illustrated in FIG. 10, as for the oval hole 21A forming the protection cover attaching portion in the third embodiment, its short diameter is sized in such a way that the cylindrical shaft 11 of the terminal protection cover 70 is rotatable within the substantially oval shape. In this embodiment, the upper portion from the view of FIG. 10 (at the side of the fringe 21a) of the hole 21A is shaped into arc, a half of the lower portion of the terminal opening 27 is shaped into a straight line and the other half is shaped into a curved line.

When the protection cover main portion 10 is attached to the terminal opening 27 of the body 100, the protrusion 13 of the rotational shaft portion of the terminal protection cover 70 is inserted into the hole 21A of the protection cover attaching portion, and after inserting the tongue-shaped piece 12 into the oval hole 21A, the terminal protection cover 70 is rotated at 90 degrees with the cylindrical shaft 11 put around the arc portion of the upper portion of the hole 21A.

As illustrated in FIG. 7, FIG. 8, and FIG. 9, in the hook of the terminal protection cover 70 according to the third embodiment of the invention, of the tongue-shaped piece 12a and the protrusion 13a forming the hook of the first embodiment, the tongue-shaped piece 12a is formed into a shape having a cut-off portion 17 according to the shape of the hole 21A of the protection cover attaching portion. Namely, one portion corresponding to the curved portion of the lower portion of the hole 21A, in the tongue-shaped piece 12a, is cut away, hence to form a cut-off portion 17 tapering. By providing the tongue-shaped piece 12a with the cut-off portion 17, the size of the hook itself including the tongue-shaped piece 12a and the protrusion 13a can be reduced so much compared with that of the first embodiment.

As mentioned above, in the third embodiment, one portion of the tongue-shaped piece 12a forming the hook is cut away according to the shape of the hole 21A and the tongue-shaped piece 12a is tapered. As a result, when the terminal protection cover 70 is attached to the body 100 as shown in FIG. 4 and FIG. 5, when the tongue-shaped piece 12a and the protrusion 13a is inserted into the oval hole 21A of the protection cover attaching portion, the tongue-shaped piece 12a corresponding to the lower portion of the hole 21A has less resistance, which makes its insertion easy.

Especially, one portion of the tongue-shaped piece 12a extending (in the longitudinal inward direction) from the protrusion 13a is cut away according to the shape of the hole 21A and its distal end is tapered, hence to make the insertion easier.

As illustrated in FIG. 8, FIG. 10, and FIG. 11, a rib 18 extending in the direction of the inner diameter of the hole 21A is formed in the straight line portion of the lower portion of the oval hole 21A forming the protection cover attaching portion. This rib 18 is formed into a shape having an inclined cross section tapering inwardly from the outside of the hole 21A of the cover 23, as shown in FIG. 11.

According to this, by forming the rib 18 in the inner deep end of the protection cover attaching portion, the terminal protection cover 70 can be satisfactory prevented from dropout with the tongue-shaped piece 12a hung on the rib 18 when the tongue-shaped piece 12a and the protrusion 13a of the terminal protection cover 70 is inserted into the oval hole 21A.

Further, since the cross section of the rib 18 is slanted tapering inwardly, when the tongue-shaped piece 12a and the protrusion 13a of the terminal protection cover 70 is inserted into the oval hole 21A, the distal end of the tongue-shaped piece 12a gets over the rib 18 of the oval hole 21A easily, hence to make the insertion of the tongue-shaped piece 12a and the protrusion 13a easy without disturbing workability.

Moreover, when the protection cover 70 is rotated around the rotational shaft 11, although there is a possibility of producing a space between the unit of the tongue-shaped piece 12a and protrusion 13a of the terminal protection cover 70 and the hole 21A, even when there is a space therebetween, it is possible to cover the space and keep a good light blocking effect and dust proof ability by forming the rib 18 inwardly extending to the hole 21A of the protection cover attaching portion.

As mentioned above, in the third embodiment of the invention, one portion of the tongue-shaped piece 12a forming the hook is cut away according to the shape of the hole 21A and the whole tongue-shaped piece 12a is shaped into tapering and reduced in size, hence to obtain a good effect of making the insertion easier at the attachment time.

By forming the rib 18 in the inner portion of the oval hole 21A forming the protection cover attaching portion, it is possible to prevent from dropout of the terminal protection cover 70 and keep a good light blocking effect and dust proof ability.

In the embodiment, although the oval hole 21A is shaped into the shape, for example, as shown in FIG. 10, this shape is not restricted to the above, but the lower portion may be shaped into arc similarly to the upper portion or the hole 21A may be shaped into rectangle.

As described above, the invention has the following effects.

As a first effect, the firm fixation of the terminal protection cover can be secured in any other direction than the inserting direction because the inserting direction at a time of attaching the terminal protection cover to the body is restricted to only one direction different from the cover attached direction.

As a second effect, the firm fixation of the terminal protection cover can be secured even when the terminal protection cover is rotated from the ordinary attached direction to the inserting direction, at a time of using the terminal, because the terminal protection cover is pressed into the body. Since the terminal protection cover is made from elastic material such as rubber and the like and a combination of the tongue-shaped piece and the protrusion is used for the hook, the terminal protection cover can be attached to the body easily while selecting the optimum angle at the attachment time.

As a third effect, since the terminal protection cover attaching portion is formed by the “hook+cylindrical shaft” and the attached portion of the body corresponding to the attaching portion is formed into the “oval hole”, it is possible to rotate the protection cover around the cylindrical shaft as well as to close and open the protection cover after the hook is fitted into the oval hole in order to attach the terminal protection cover to the body.

1. An electronic apparatus comprising:
a body including a first attached body portion and a second attached body portion; and
a terminal protection cover including a first attaching cover portion and a second attaching cover portion, wherein
after said first attaching cover portion is attached to said first attached body portion, said second attaching cover portion is rotated around said first attaching cover portion and said second attaching cover portion is fitted to said second attached body portion.

2. The electronic apparatus as set forth in claim 1, wherein
said first attached body portion and said second attached body portion are a first opening and a second opening aligned in a first direction,
said first attaching cover portion and said second attaching cover portion are respectively a rotational shaft portion to be inserted into said first opening and a cover main portion to be fitted into said second opening, and
after said rotational shaft portion is inserted into said first opening, said cover main portion is rotated around said rotational shaft portion and said cover main portion is fitted into said second opening.

3. The electronic apparatus as set forth in claim 2, wherein
said first opening is an oval having its longitudinal direction in a second direction,
said second opening is a rectangular having its longitudinal direction in said first direction,
said rotational shaft portion includes a cylindrical shaft and a hook at the distal end of said shaft,
said cover main portion has a shape to be fitted into said second opening, and
after said shaft and hook are inserted into said oval opening, said cover main portion is rotated around said shaft and said cover main portion is fitted into said rectangular opening.

4. The electronic apparatus as set forth in claim 3, wherein
said hook includes a tongue-shaped piece and a protrusion in the longitudinal direction of said cover main portion, with said shaft intervening therebetween.

5. The electronic apparatus as set forth in claim 3, wherein
said hook includes a tongue-shaped piece and a protrusion in the longitudinal direction of said cover main portion, with said shaft intervening therebetween, and
two small protrusions arranged in a direction perpendicular to the longitudinal direction of said cover main body, with said shaft intervening.

6. The electronic apparatus as set forth in any of claims 1 to 5, wherein
said terminal protection cover is made from elastic material.

7. The electronic apparatus as set forth in any of claims 1 to 5, in which
one portion of said second attaching cover portion is cut away according to a shape of said first attached body portion.

8. The electronic apparatus as set forth in claim 7, wherein
by cutting away one portion of said second attaching cover portion, said second attaching cover portion is tapered.

9. The electronic apparatus as set forth in claim 7, wherein
a rib extending toward a direction of the inner diameter is provided in said first attached body portion at the inner portion corresponding to said first attaching cover portion.

10. The electronic apparatus as set forth in claim 9, wherein
said rib is formed into a shape having an inclined cross section tapering inwardly from the outside of said body.

11. A mobile phone to which the electronic apparatus as set forth in any of claims 1 to 5 is applied.

12. A method of attaching a terminal protection cover for an electronic apparatus which comprises
a body including an oval opening having its longitudinal direction in a second direction and a rectangular opening having its longitudinal direction in a first direction, which openings are aligned in said first direction, and
a terminal protection cover rotatable and including a rotational shaft portion having a hook at the distal end of a cylindrical shaft and a cover main portion formed into a shape to be fitted into said rectangular opening,
the method comprising the steps of:
a step of inserting said rotational shaft into said oval opening, and
a step of rotating said cover main portion around said rotational shaft and fitting said cover main portion to said rectangular opening.
